(19) United States
(12) Patent Application Publication
(10) Pub. No.: US 2013/0255807 A1
(43) Pub. Date: Oct. 3, 2013

(54) Vent Valve for Diver's Buoyancy Compensator

(71) Applicants: David Bonzon, Mont-Pelerin (CH); Andrew Sinclair, les Collons (CH); Christophe Glez, Chardonne (CH); Christopher Webb, les Collons (CH)

(72) Inventors: David Bonzon, Mont-Pelerin (CH); Andrew Sinclair, les Collons (CH); Christophe Glez, Chardonne (CH); Christopher Webb, les Collons (CH)

(21) Appl. No.: 13/432,069

(22) Filed: Mar. 28, 2012

(51) Int. Cl. F16K 31/00; B63C 11/02

(52) U.S. Cl. 137/624.27; 405/186

(57) ABSTRACT

A vent valve for a buoyancy control device suitable for free-swimming divers, where the valve may be opened both manually and by a powered means, such as from a hydraulic or pneumatic pressure line, the hydraulic or pneumatic pressure being equalised with the ambient pressure when not activated.

### TECHNICAL FIELD

The present invention relates to a vent valve for use on a diver's buoyancy jacket, that is either manually operated or automatically operated that operate as a set of at least three valves operating simultaneously.

### BACKGROUND OF THE INVENTION

Diver's commonly use a Buoyancy Compensation Device (BCD) to compensate for the changes in buoyancy that occur during dive, such as from the compression of the neoprene in a diver's environmental protection suit, or from the consumption of gas in a dive cylinder. A means to add gas to a bladder in the BCD enables the diver's buoyancy to be increased, and vent valves allow gas to be discharged and hence reduce the diver's buoyancy by reduction of the water volume displaced by the bladder.

If a volume of gas is in a bladder underwater, then the gas will not flow out of a vent in the bladder unless the vent is higher than the gas: gas does not flow from a low pressure to a high pressure region on its own. This means that a minimum of three valves are required to guarantee that gas can be vented in any orientation of the diver.

The drawback of having three or more vent valves is .that in the event of an undesirable increase in buoyancy, the diver may have to try each valve in turn in order to identify which one releases gas. Not all the valves, may be easily reachable.

It is desirable to have a method to open all the vent valves simultaneously.

It is obvious that if more than one vent valves is open at once, then one-way valves have to be fitted to prevent water ingress.

In water the ambient pressure will tend to collapse a bladder such that even if the gas is at the same ambient pressure as the vent, it may not flow to the vent unless there is an open gas path from the region containing the gas to the vent. Such gas paths may be kept open within a bladder by fitting a spiral or spring inside the bladder. The advantage of having multiple paths to vent valves open is that gas maybe dumped more rapidly.

The vent valves in common use on BCDs have a pull cord attached to a stopper, which allows for manual control of the valve.

The prior art includes various devices that link together multiple pull-cords.

U.S. Pat. No. 6,217,257 describes a diver's buoyancy device with multiple vent valves that are controlled pneumatically, with one-way valves to prevent water ingress.

U.S. Pat. No. 6,217,257 describes the control means to actuate the valve as being a push-button which provides a pressurised gas supply to a piston that lifts the valve. It does not describe how the pressure is released the patent appears to provide no means to release the pressure. That is, operating the button described in the patent would pressurise the pneumatic line to the vent valve, which in turn would cause the valves to lift but there is no means to release the gas pressure in the line described, so the valve would remain lifted and the buoyancy bladder would lose all its contained gas.

Another limitation of the prior art such as in the form, of a vent valve in U.S. Pat. No. 6,217,257 is that the addition of a pull-cord is not feasible to the form described because the cord would normally feed through the device for which a gas tight connection is required for the device in FIG. 2 of U.S. Pat. No. 6,217,257 to operate.

Yet another limitation of the prior art, such as U.S. Pat. No. 6,217,257, is that a loss of pneumatic power would result in the valve becoming inoperable.

Yet another limitation of the prior art, such as U.S. Pat. No. 6,217,257, is that it is not possible to open the valve manually because if the pneumatic supply is shut then to move the Valve would involve pulling a partial vacuum manually.

The activation of pneumatic valves underwater invariably involves power from a gas cylinder, as the use of a flexible gas volume would operate the vents as the volume comes under increasing ambient pressure as the diver's depth increases.

### OBJECT OF THE PRESENT INVENTION

It is an objective of the present invention to provide a pneumatic or hydraulic power to a BCD vent valve such that a loss of power causes the valve to fail in a safe state.

It is a further objective of the present invention to enable all the vent valves on a BCD to be opened or closed with a single action.

It is a further objective of the present invention to provide a vent valve suitable for use by an automatic buoyancy compensation device.

It is a further objective of the present invention to provide manual control of the valves in the event of loss of pneumatic or hydraulic power.

### BRIEF SUMMARY OF THE INVENTION

The present invention provides a pneumatically controlled vent valve that has a manual over-ride active at all times to enable the valve to be opened, by the attachment of a pull-cord to a stopper or plug in the valve.

The present invention provides a fail-safe means to operate the valve using any gas or liquid.

### BRIEF DESCRIPTION OF THE DRAWINGS

For a better understanding of the present invention, and the advantages thereof and to show how the same may be carried into effect, reference will now be made, by way of example, without loss of generality to the accompanying drawings in which:

FIG. 1 shows a pneumatically activated vent valve according to the present invention which provides a consistent operating force and seating of the valve.

FIG. 2 shows an example embodiment of an hydraulic drive providing fail-safe features.

### DETAILED DESCRIPTION OF THE INVENTION

The invention will now be described in detail .by reference to the aforementioned figures and by use of example embodiments. Reference is made to a BCD bladder. It is not important the form of the bladder the present invention many be applied to many different types of bladder. The sole special requirement for the bladder to be used with the present invention is that the vent valves shall be arranged such that in any orientation of the bladder there is an open gas path from the gas in the bladder to one of the vents: at least three vent valves are required to fulfil this requirement.

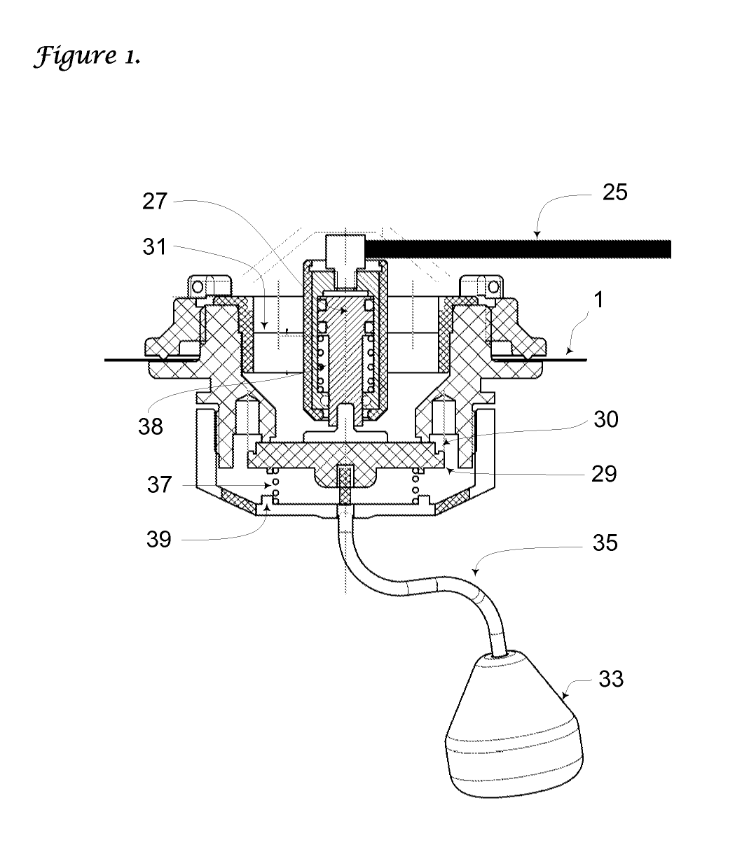

The vent valves in an example embodiment shown in FIG. 1 have a conventional manual pull dump (33) in addition to a pneumatically or hydraulically powered piston (27). The pull dump may be on a cord (35) or a lever.

A hose (7) carries the gas from the inflator to the actuators is preferably is a narrow bore hose. Kynar hoses are available with a 0.8 mm bore and an outer diameter of 3.6 mm, which have the effect of limiting the maximum flow rate when used with typical BCD gas supply pressures to around 20 litres of gas flow per minute, and have a burst pressure exceeding the gas supply cylinder high pressure, such that if the first stage cylinder pressure regulator were to fail, then the hose (7) would not rupture, and therefore there is no risk of the bladder in the BCD being inflated suddenly. Moreover, use of a very small bore hose means that should the hose break, the flow rate into the bladder is much lower than the minimum vent rate if the diver uses the manual vent controls on the vent valves.

The supply hose (7) to the gas valves and is preferably flow limited by its bore, and the vent valves such as shown in FIG. 1 incorporate springs (37) and optionally (38) that close the valve when it is not powered. It is possible but not preferable to add a further flow restriction by use of an orifice or choice of small bores within the connectors to the gas hose (7) or gas routing manifold.

Vent valves (2) with the features shown in FIG. 1 namely an input gas hose (25), pressure in which causes a piston (27) to move and open a plug or stopper (29), allowing gas in the bladder to escape through a one-way valve (31). A. manual pull-dump (33) is preserved in the preferred embodiment, allowing manual operation of the vent by the diver at any time. The pull-dump cords (35) may be singular or may be combined: a minimum of three of the vent valves (2) must be fitted to the bladder in positions such that there is an open gas path between the retained gas in the bladder and at least one vent valve when the bladder is immersed in water. A novel feature of the vent valves in the preferred embodiment is the use of a wave spring (37) to apply even pressure to the plug (29) such that seats evenly. Retainers (39) prevent the spring (37) from being displaced laterally.

The use of the wave spring avoids the valve leaking if it is operated manually with a motion that in a conventional vent valve would tend to cause the plug, (29) to take up an angle instead of remaining level with respect to the valve seat(30). A wave spring is a type of compression spring built from a series of thin washers that have a wave-like profile. Compressing the washers, which are normally welded together, results in a reactive force that is even around the circumference of the spring. A wave spring can also provide a greater extension for a particular spring force and spring bound size than a conventional wire compression spring, which can be advantageous in this application.

A key feature of the vent valve is that the plug (29) is not firmly attached to the piston (27), such that pulling the plug (29) via the cord (35) causes the plug (29) to lift off the seat (31) without the piston (27) having to move. The seat at the top of the piston (27) need not be attached to the plug (29).

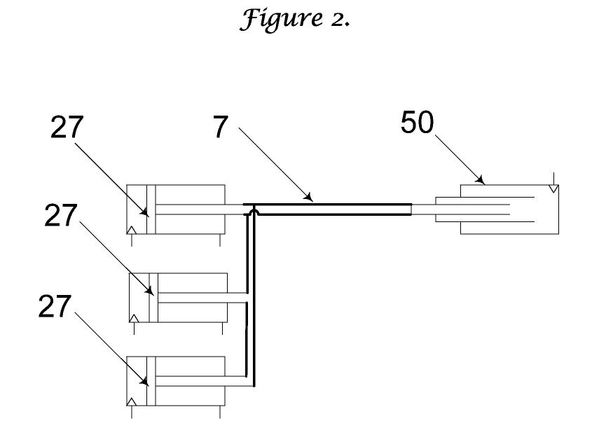

The pneumatic power may be provided by an arrangement of gas valves that apply a lower gas pressure, such as 9 bar, to the hose (7) to activate the valve, but which in the/quiescent or inactive state opens the gas line to the BCD bladder. When the gas hose (7) is a small bore hose then the volume of the gas vented to the bladder may be kept to a negligible amount.
An alternative to the pneumatic power to activate the vent valve is shown in FIG. 2, namely a hydraulic power source. In this case a bellows (50) contains a liquid such as alcohol or water or silicone oil, and pressure on the bellows by the user causes pressure to build up in the hose (7) and the valve to be opened. The spring bias to the bellows causes the liquid to pull back the piston when the pressure is removed. The pressure may be through a lever or directly on the bellows.
The bellows (50) or the hose (7) have a means through which gas cap be drained and fluid topped up, but such means may be in the form of a nipple or filling point: there is no need for a hydraulic reservoir. During the filling process, sufficient provision should be made for the thermal expansion of the hydraulic liquid: this can be accommodated by a partial fill such that expansion of the liquid extends the bellows (50) and contraction causes them to shrink in size, but leaving sufficient movement for the manual action.

The bellows (50) may implemented in a variety of forms, including a thick walled balloon such as a silicone moulding, or it may be a telescoping moulding, or it may be a series of telescoping elements with O-ring seals. This invention is not limited to the specific embodiments disclosed herein which is intended to be illustrative and it covers all modifications and alternatives coming within the scope and spirit of the invention as defined in the attached claims.

We claim:

1. A device comprising a valve for venting gas from a bladder that is opened by pressure in a pneumatic or hydraulic hose connecting to at least three vent valves which are opened simultaneously by that pressure and when open vent gas from the bladder, and further comprising a manual means for opening the valve, such that pulling on a manual pull dump is not resisted by the piston that provides the pneumatic or hydraulic motion, and in which water ingress into the bladder is restricted by use of a one-way valve in series with the vented gas flow.

2. A device according to claim 1 wherein the said vent valves are configured to be opened by a pneumatic pressure and configured to be closed by a counterforce created by or assisted by a wave spring in addition to a pull-cord enabling the valve to be opened manually.

3. A device according to claim 1 further comprising gas valves arranged such that a loss of electrical or gas power causes the valves to fail in a safe state in which the valve is closed and the manual action of the valve remains operable.

4. A device according to claim 1 incorporating a safety means to shut down the automatic buoyancy control system without affecting the ability of the diver to perform buoyancy control manually.
